(19) United States
(12) Patent Application Publication
(10) Pub. No.: US 2008/0123732 A1
(43) Pub. Date: May 29, 2008

(54) METHOD AND SYSTEM FOR CONFIGURING DECODING BASED ON DETECTING TRANSPORT STREAM INPUT RATE

(76) Inventors: Rajesh Mamidwar, San Diego, CA (US); Brett Jason Andrews, Huntington Beach, CA (US); Prashant Katre, Escondido, CA (US)

Correspondence Address: MCANDREWS HELD & MALLOY, LTD, 500 WEST MADISON STREET, SUITE 3400, CHICAGO, IL, 60661, US

(21) Appl. No.: 11/563,403

(22) Filed: Nov. 27, 2006

(51) Int. Cl. H04B 1/66

(52) U.S. Cl. 375/240.01

(57) ABSTRACT

Systems and methods for processing multimedia information are disclosed and may include adjusting a decoding rate for a received transport stream based on a ratio of a plurality of accumulated program clock reference (PCR) values and a corresponding plurality of accumulated system time clock (STC) values. The received transport stream may include a plurality of audio samples. A portion of the plurality of audio samples may be decoded based on the adjusted decoding rate. The plurality of PCR values within the received transport stream may be detected and stored within on-chip memory. The plurality of STC values may be generated based on incrementing a counter during decoding of the received transport stream. The generated plurality of STC values may be stored within on-chip memory. A first difference between a current PCR value and a subsequent PCR value may be calculated.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### FIELD OF THE INVENTION

Certain embodiments of the invention relate generally to processing of packetized data. More specifically, certain embodiments of the invention relate to a method and system for configuring decoding based on detecting transport stream input rate.

### BACKGROUND OF THE INVENTION

As the speed of Internet traffic increases, on-demand television and video are becoming closer and closer to reality. The introduction of broadband networks, headend and terminal devices such as set-top boxes, and media such as DVD disks recorded with digitally compressed audio, video and data signals, for example, which utilize Motion Picture Expert Group (MPEG) compression standards, may provide sound and picture quality that is virtually indistinguishable from the original material. One of the most popular MPEG standards is MPEG-2, which provides the necessary protocols and infrastructure that may be used for delivering digital television or DVD contents with compressed audio, video and data signals. The MPEG-2 compression scheme compresses and packetizes the video content into MPEG-2 packets. A detailed description of the MPEG-2 standard is published as ISO/IEC Standard 13818.

In addition to the increasing speed of Internet transactions, continued advancement of motion picture content compression standards permit high quality picture and sound while significantly reducing the amount of data that must be transmitted. A compression standard for television and video signals was developed by the Moving Picture Experts Group (MPEG), and is known as MPEG-2. An encoded bitstream, such as an MPEG-2 bitstream, comprises different types of data. For example, an MPEG-2 bitstream may comprise audio information, video information, and additional data. A transmitted MPEG-2 bitstream may be received by a set-top box (STB), for example, and the STB may further process the received bitstream. However, since the received bitstream comprises multiple types of data, the STB may utilize multiple decoders. Using multiple decoders to parse the received bitstream is time consuming and may result in processing delays. Furthermore, audio glitches may be generated during decoding when the transport stream input rate, or the played stream rate, may be different from the actual stream rate.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A method and system for configuring decoding based on detecting transport stream input rate, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram of an exemplary system for encoding an MPEG stream, which may be utilized in accordance with an embodiment of the invention.

FIG. 1B is a block diagram of an exemplary packet in an MPEG stream.

FIG. 1C is a diagram of the structure for an exemplary MPEG transport stream, in accordance with an embodiment of the invention.

FIG. 2 is a block diagram of an exemplary MPEG encoding system that may be utilized in accordance with an embodiment of the invention.

FIG. 3 is a block diagram of an exemplary MPEG decoding system that may be utilized in accordance with an embodiment of the invention.

FIG. 4 is a flow diagram illustrating exemplary steps for processing multimedia information, in accordance with an embodiment of the invention.

### DETAILED DESCRIPTION OF THE INVENTION

Certain embodiments of the invention may be found in a method and system for configuring decoding based on detecting transport stream input rate. Aspects of the invention may include adjusting a decoding rate for a received transport stream based on a ratio of a plurality of accumulated program clock reference (PCR) values and a corresponding plurality of accumulated system time clock (STC) values. The received transport stream may comprise a plurality of audio samples. A portion of the plurality of audio samples may be decoded based on the adjusted decoding rate. The plurality of PCR values within the received transport stream may be detected and stored within on-chip memory. The plurality of STC values may be generated based on incrementing a counter during decoding of the received transport stream. The generated plurality of STC values may be stored within on-chip memory. A first difference between a current PCR value and a subsequent PCR value may be calculated. The current PCR value and the subsequent PCR value may be selected from the plurality of accumulated PCR values. Similarly, a second difference between a current STC value and a subsequent STC value may be calculated. The current STC value and the subsequent STC value may be selected from the plurality of accumulated STC values. The decoding rate for the received transport stream may then be adjusted based on a ratio of the first difference and the second difference.

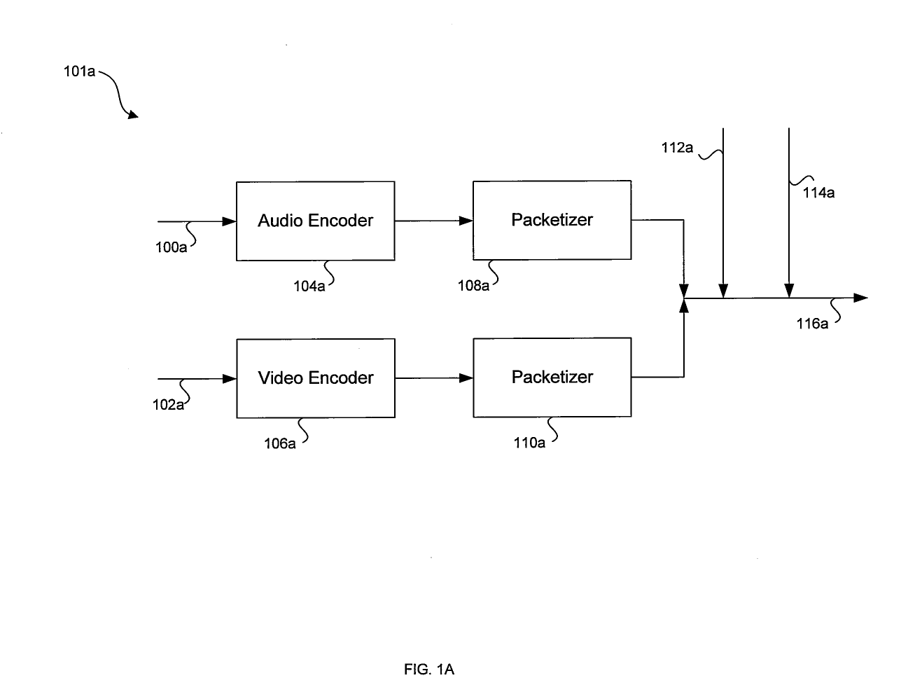

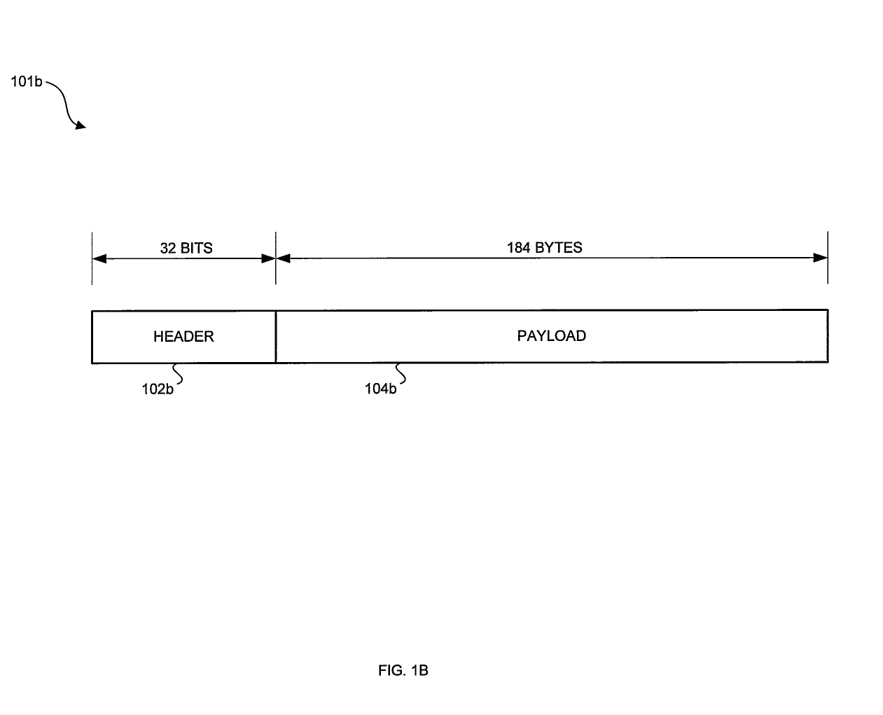

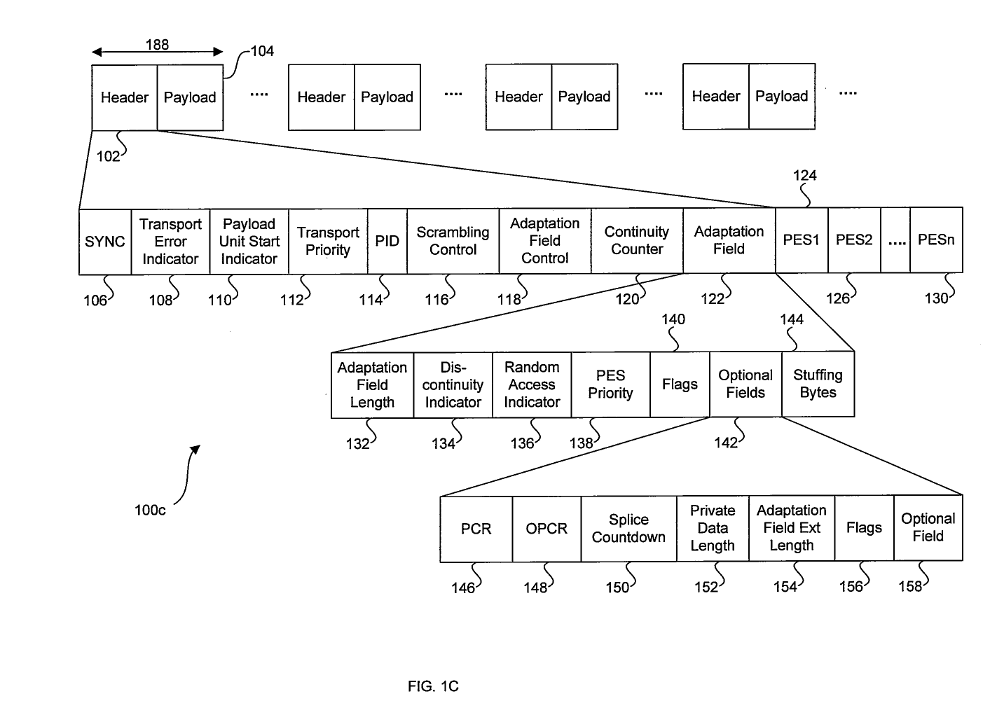

FIG. 1A is a block diagram of an exemplary system for encoding an MPEG stream, which may be utilized in accordance with an embodiment of the invention. Referring to FIG. 1A, the exemplary system 101a for encoding an MPEG bitstream may comprise an audio encoder 104a, a video encoder 106a, and packetizers 108a, 110a. The audio encoder 104a may comprise suitable circuitry, logic, and/or code and may be enabled to encode audio information 100a. The video encoder 106a may comprise suitable circuitry, logic, and/or code and may be enabled to encode video information 102a. The packetizers 108a and 110a may comprise suitable circuitry, logic, and/or code and may be adapted to arrange encoded audio and video information, respectively, into packets for transmission.

In operation, the audio encoder 104a may encode the audio information 100a to generate an audio elementary stream (ES). The packetizer 108a may then packetize the audio ES. Similarly, the video encoder 106a may encode the video information 102a to generate a video ES. The packetizer 110a may then packetize the video ES. In MPEG-2, the audio ES and video ES may encapsulate additional information, such as decoding and presentation timestamps, to generate packetized elementary streams (PES). The PES may include a header that may precede one or more payload bytes. The header may include information pertaining to the encoding process required by an MPEG decoder to decompress and decode a received ES. Each individual ES may have a corresponding PES and any encoded audio and video information may still reside in separate PESs. Notably, the PES may be viewed primarily as a logical construct and may not be utilized for data interchange, transport, and interoperability. Notwithstanding, the PES may be utilized for conversion between two types of system streams, namely, transport stream (TS) and program stream (PS).

The audio and video PES may be combined with packets containing additional data 112a and program specific information (PSI) 114a. The PSI 114a may comprise tables, which may be necessary for de-multiplexing the TS 116a in a receiver. All these streams may be encoded and multiplexed into an MPEG transport stream (TS) 116a for transmission. To maintain synchronization and timing, null packets may also be inserted to fill the intervals between information-bearing packets. Timing information for an associated program may be carried by specific packets. The TS 116a may be modulated for transmission via local television digital broadcast, for example. The TS 116a may be de-multiplexed, and compressed video and audio streams may be decoded in a set-top box (STB) and viewed on a TV. The STB may utilize one or more parsers to parse and demultiplex the received TS 116a. In this regard, the parsers may utilize PID information, which may be stored in a table in memory, to determine whether to accept or reject a particular packet from the received TS 116a. TS packets may have a fixed length of 188 bytes, which may include a header having a minimum size of 4 bytes and a maximum payload of 184 bytes.

In existing MPEG compliant systems, audio/video streams may be carried using MPEG-2 transport packets. Multiple streams may be differentiated using a PID contained in a packet header called the transport packet header. Transport packets from various streams may be multiplexed and transmitted on the same physical medium. Exemplary media may include copper, coaxial cable, wireless, optical and any combination thereof. On the receiver side transport packets may be de-multiplexed and data may be separated for each stream. For example, audio packets may be extracted from the transport stream and separated from video packets utilizing PID information.

Transport packets may include three fields, namely a 4-byte header, an optional adaptation field and a packet payload. The packet payload may not be altered by multiplexing or transmitting equipment, except during processing which may include data encryption and decryption. Encryption may be performed once within a typical MPEG processing system. Notwithstanding, some fields of adaptation field may be changed by multiplexing and transmission equipment. Typically, packet order within a PID channel may be maintained from an MPEG encoder to an MPEG receiver but packet order among multiple PID streams may not be guaranteed during transmission by any transmitting equipment. In cases where co-relation of packets from different PIDs may be required, packet position in a stream cannot be utilized since packet order among multiple PID channels may be altered.

FIG. 1B is a block diagram of an exemplary packet in an MPEG stream. Referring to FIG. 1B, the MPEG-2 packet 101b may comprise a header 102b and a payload 104b. The header 102b may comprise 32 bits and the payload 104b may comprise 184 bytes. In this regard, an MPEG-2 packet 101b may comprise 1504 bits.

MPEG-2 packets, such as packet 101b, may be received within a STB as a continuous stream of serial data. Recovery of the original video and/or audio content may require parsing the continuous stream of serial data into the individual constituent packets. Given the starting point of an MPEG-2 packet, a transport stream receiver may be enabled to parse the continuous stream into the individual constituent data packets by counting the number of bits received since the MPEG-2 packets are of a known uniform length of 1504 bits. The starting point of a packet, such as packet 101b, may be determined by calculation and detection of a predetermined eight-bit checksum, for example. Detection of the predetermined checksum may be indicative of the beginning of the MPEG-2 packet 101b. In addition, detection of the predetermined checksum may be used to establish MPEG synchronization and lock alignment. Once alignment has been locked, the absence of the predetermined checksum at expected locations, such as every 1504 bits, may be indicative of bit errors.

FIG. 1C is a diagram of the structure for an exemplary MPEG transport stream, in accordance with an embodiment of the invention. Referring to FIG. 1C, the transport stream (TS) 100c may comprise a plurality of TS packets. Each TS packet may comprise a header 102 and payload 104, which may total 188 bytes. The TS packet header 102 may include the following fields: synchronization (SYNC) 106, transport error indicator 108, payload unit start indicator 110, transport priority 112, packet identifier (PID) 114, transport scrambling control 116, adaptation field control 118, continuity counter 120, and adaptation field 122. The adaptation field 122 may further comprise the following fields: adaptation field length 132, discontinuity indicator 134, random access indicator 136, ES priority 138, flags 140, optional fields 142, and stuffing bytes 144. The optional fields 142 may further comprise the following: program clock reference (PCR) 146, OPCR 148, a splice countdown 150, private data length 152, adaptation field extension length 154, flags 156, and optional field 158. The payload 104 may comprise a plurality of portions of a single PES, such as PES1 124, PES2 126, . . . , PESn 130.

The TS 100c may comprise variable length PESs that may be divided into fixed length packets for use by a transmission system. In this regard, the information added by the TS 100c may be additional to the information contained in the headers of the PESs. SYNC byte 106 may be used to delineate the beginning and ending of TS packet 100c. The transport error indicator 108 may indicate when there is an error in a packet or block. This may be particularly useful for error block detection.

The packet identifier (PID) 114 may be a unique identifier that may identify a video and an audio stream. Additionally, each PSI table may have a unique PID 114. The PID 114 may be utilized for identifying a channel and may include any information required for locating, identifying and reconstructing programs. The PID may identify packets belonging to the same data stream, which facilitates reconstruction of the data stream within a STB, for example. Some PIDs may be reserved for specific uses by the MPEG protocol. PID values may be stored in PSI tables, for example, within the bitstream receiver, such as the STB. In order to ensure that all the audio, video and data for a program are properly decoded, it may be critical to ensure that the PIDs are correctly assigned and that the PSI tables correspond with their associated audio and video streams.

PCR 146 may comprise 42 bits, which may represent 27 MHz clock ticks, and 33 bits of PCR base may represent 90 kHz ticks. The bits in PCR 146 may provide program clock recovery information that may be utilized for synchronization. PCR 146 may be used to provide a clock recovery mechanism for MPEG programs. A 27 MHz system time clock (STC) signal may typically be used for encoding MPEG signals. Decoding of the signal requires a clock that may be locked to the encoder's STC of 27 MHz. Notably, the PCR 146 may be utilized by the decoder to regenerate a local clock signal that is locked to the encoder's STC. Whenever a program is placed in the transport stream, a 27 MHz time stamp may be inserted into the PCR 146. When the signal is received by a decoder, the decoder may compare the value in the PCR 146 with the frequency of its local voltage controlled oscillator (VCO) and adjust the VCO to ensure that the VCO is locked to the frequency specified by the PCR 146. To ensure accuracy, the PCR 146 may be updated with the STC roughly every 100 ms.

The continuity counter (CC) 120 may be used to determine when packets are lost or repeated. It may include a 4-bit field, which may be repeatedly incremented from zero to 15 for each PID. Discontinuity indicator 134 may permit a decoder to handle discontinuities in the transport stream. Discontinuity indicator 134 may indicate a time base such as the PCR 146 and continuity counter 120 discontinuities. Random access indicator 136 may be configured to indicate whether the next PES packet in the PID stream contains a video-sequence header or the first byte of an audio frame. Splice countdown 150 may be configured to indicate the number packets of the same PID number to a splice point occurring at the start of PES packets.

An MPEG TS may be a multi-program TS or a single program TS (SPTS). A number of SPTSs may be multiplexed to create a multi-program TS. In some cases, the program may include one or more ESs that may have a similar time reference. This may occur, for example, in a movie that has video and its corresponding audio content.

PSI may include a set of tables that may be part of a TS. The tables in the PSI may be required while de-multiplexing the TS and for matching PIDs to their corresponding streams. Once the PIDs are matched to their corresponding streams, the TS may be decoded by assembling and decompressing program contents. Typically, in order to determine which audio and video PIDs contain the corresponding content for a particular stream, a program map table (PMT) may be decoded. Each program may have its own PMT bearing a unique PID value. The program association table (PAT) may be decoded in order to determine which PID contains the desired program's PMT. The PAT may function as the master PSI table with PID value always equal to 0. In a case where the PAT cannot be found and decoded in the TS, no programs may be available for presentation. Each parser within an MPEG demultiplexer may access PID information for a particular data channel and received MPEG transport stream may be parsed based on the PID information.

The PSI table may be refreshed periodically at a rate that is fast enough to allow a STB to go through program recovery and decompression processes. This may be necessary to ensure real-time user interaction. The PSI may also be used to determine the accuracy and consistency of PSI contents. Notwithstanding, during programs changes or modification of multiplexer provisioning, there may be packets which have a PID value present in the TS, but have no corresponding reference in the PSI. Additionally, the PSI may have references to one or more PIDs that are not present in the TS.

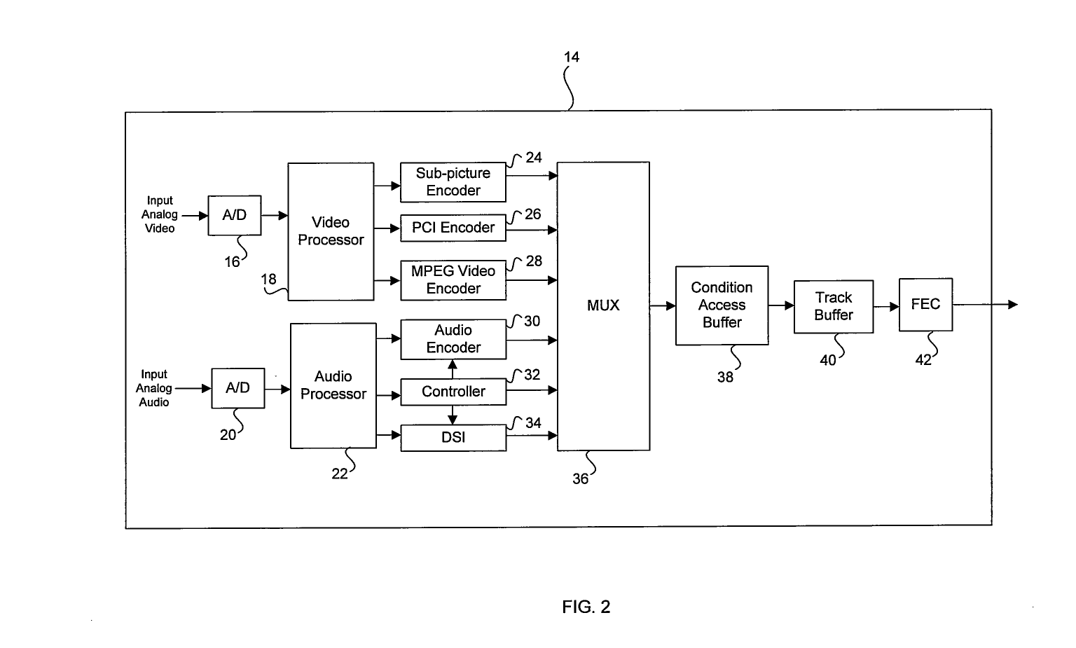

FIG. 2 is a block diagram of an exemplary MPEG encoding system that may be utilized in accordance with an embodiment of the invention. Referring to FIG. 2, an analog input video signal may be converted to digital format by A/D converter 16. An output signal from the A/D converter 16 may be communicated to video processor 18 for processing. After the video processor 18 processes the signal, the output signal generated from the video processor 18 may be sent to a sub-picture encoder 24 for processing. A presentation control information (PCI) encoder 26 may be configured to encode PCI data for the video signal processed by video processor 22. The output signal generated from the video processor 18 may also be received and processed by an MPEG video encoder 28, which may be configured to format the video signal in MPEG format.

An analog input audio signal may be converted to digital format by A/D converter 20. An output signal from the A/D converter 20 may be communicated to audio processor 22 for processing. After the audio processor 22 processes the signal, the output signal generated from the audio processor 22 may be sent to an audio encoder 30 to be encoded in a suitable format. A data search information (DSI) encoder 34 may be configured to encode indexing and search data for the video signal processed by video processor 22. The outputs from the sub-picture encoder 24, PCI encoder 26, MPEG video encoder 28, audio encoder 30 and DSI encoder 34 may be multiplexed into a single data stream, by multiplexer 36. A controller 32 may be configured to control the operations of audio encoder 32, DSI encoder 34 and multiplexer (MUX) 36. The output of the MUX 36 may include a single stream, which may contain various kinds of PES. A PES may include, audio, video, PCR, DSI or sub-picture information. A single TS may comprise multiple PESs.

The MPEG encoding system 14 may also include a conditional access buffer 38 that may be configured to control propagation of the packets through MUX 36. A buffer 40 may be used to buffer and assemble data packets for further processing. Finally, the assembled packets may be encoded with a forward error correction algorithm within the forward error correction block (FEC) 42 for transmission over a channel. The output of the FEC block 42 may be an MPEG formatted digital audio/video signal.

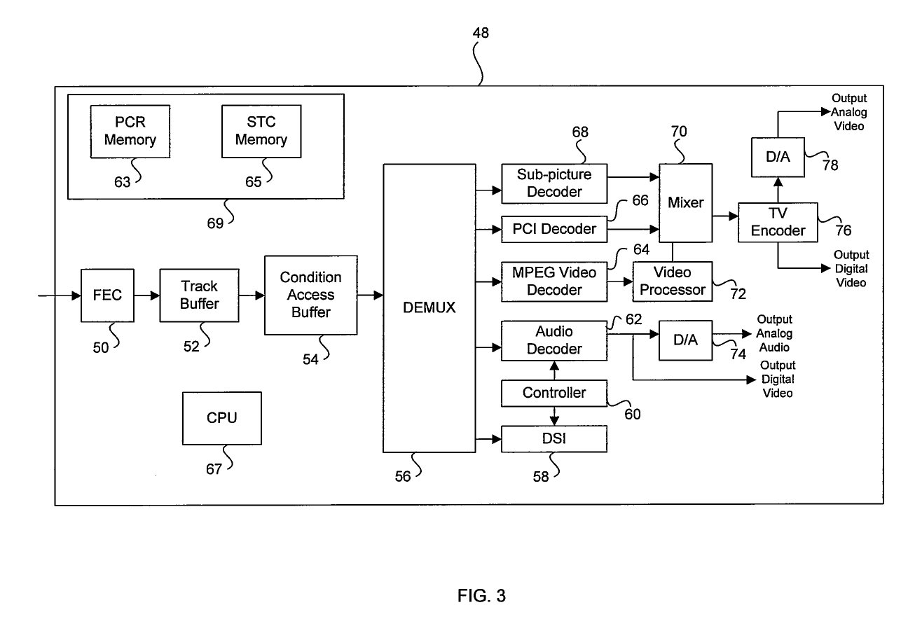

FIG. 3 is a block diagram of an exemplary MPEG decoding system that may be utilized in accordance with an embodiment of the invention. The MPEG decoding system 48 may be, for example, a set-top box. Referring to FIG. 3, the MPEG decoding system 48 may comprise a forward error correction (FEC) processing block 50 and a track buffer 52. The MPEG decoding system 48 may further comprise a program clock reference (PCR) memory 63 and a system time clock (STC) memory 65. The PCR memory 63 and the STC memory 65 may each comprise, for example, a first-in-first-out (FIFO) memory. In one embodiment of the invention, the PCR memory 63 and/or the STC memory 65 may comprise on-chip memory and may be integrated within a single chip 69. The single chip 69 may be located within the MPEG decoding system 48 or outside of the MPEG decoding system 48.

The track buffer 52 may be used to buffer and assemble data packets for further processing. The packets may be processed by a conditional access circuit 54 that may be configured to control propagation of the packets through de-multiplexer (DEMUX) 56 and into respective video and audio processing paths. The output of the DEMUX 56 may include various kinds of packetized elementary streams (PES), including audio, video, presentation control information (PCI), sub-picture information, and data search information (DSI) streams. The de-multiplexed PCI in the PES may be buffered prior to being decoded by PCI decoder 66.

The sub-picture information in the PES may be buffered and decoded by sub-picture decoder 68. The de-multiplexed video stream in the PES may be decoded by MPEG video decoder 64. Video processor 72 may be configured to process the output from the MPEG video decoder 64. Video processor 72 may be a microprocessor or an integrated circuit (IC). Subsequent to processing of the MPEG video, mixer 70 may combine the outputs of the PCI decoder 66, the video processor 64 and the sub-picture decoder 68 to form a composite video signal. The output of mixer 70 may thereafter be encoded in a conventional television signal format such as PAL, SECAM, or NTSC by the TV encoder 76. The output of the TV encoder 76 may be a digital video signal. However, D/A converter 78 may convert this digital video output signal to an analog video output signal.

The audio portion of the PES may be buffered and decoded by audio decoder 62. The output of the audio decoder 62 may be a digital audio signal. The audio D/A 74 may process digital audio received from the audio decoder 62 and produce an analog audio output signal. Audio decoder 62 may include a frame buffer sufficient for temporarily storing audio frames prior to decoding. Controller 60 may control the operation of audio decoder 62 and DSI 58. Controller 60 may be configured to utilize DMA to access to data in track buffer 52 or any other associated memory (not shown).

In one embodiment of the invention, the MPEG decoding system 48 may detect one or more program clock reference (PCR) values within the packetized elementary streams generated by the DEMUX 56. The detected PCR values may be stored in the PCR memory 63. Additionally, the MPEG decoding system 48 may utilize a local clock, such as a 27 MHz clock, to increment a counter and generate system time clock (STC) values. The generated STC values may be stored within the STC memory 65. In another embodiment of the invention, each of the PCR memory 63 and the STC memory 65 may comprise a FIFO memory with a depth of five. In this regard, the PCR memory 63 may store five subsequent PCR values (PCR1, . . . , PCR5), and the STC memory 65 may also store five corresponding STC values (STC1, . . . , STC5). A ratio may then be calculated using one or more of the stored PCR values (PCR1, . . . , PCR5) and one or more corresponding STC values (STC1, . . . , STC5).

The calculated ratio may be indicative of changes in the encoded stream rate versus the played stream rate, and may be used for configuring the decoder and adjusting the decoding speed and/or for smoothing out reading of audio samples to avoid glitches. In another embodiment of the invention, the ratio r may be calculated by using the following equation:

$$r = \frac{( PCR 5 - PCR 1 )}{( STC 5 - STC 1 )} ,$$

where PCR5 is a current PCR value, PCR1 is a previous PCR value saved within the PCR memory 63, STC5 is a current STC value, and STC1 is a previous STC value saved within the STC memory 65.

In another embodiment of the invention, the MPEG decoding system 48 may be implemented as a single chip.

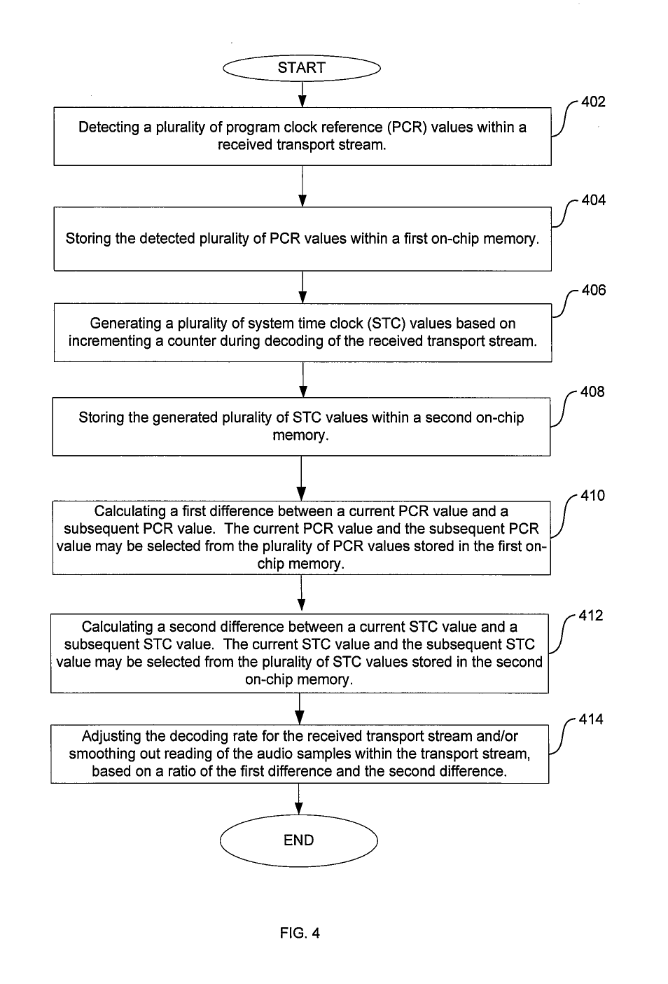

FIG. 4 is a flow diagram illustrating exemplary steps for processing multimedia information, in accordance with an embodiment of the invention. Referring to FIGS. 3 and 4, at 402, the MPEG decoding system 48 may detect a plurality of program clock reference (PCR) values within a received transport stream. At 404, the MPEG decoding system 48 may store the detected plurality of PCR values within a first on-chip memory, such as the PCR memory 63. At 406, the MPEG decoding system 48 may generate a plurality of system time clock (STC) values based on incrementing a counter during decoding of the received transport stream. At 408, the MPEG decoding system 48 may store the generated plurality of STC values within a second on-chip memory, such as the STC memory 65. At 410, the MPEG decoding system 48 may calculate a first difference between a current PCR value and a subsequent PCR value. The current PCR value and the subsequent PCR value may be selected from the plurality of PCR values stored in the PCR memory 63. At 412, the MPEG decoding system 48 may calculate a second difference between a current STC value and a subsequent STC value. The current STC value and the subsequent STC value may be selected from the plurality of STC values stored in the STC memory 65. At 414, the MPEG decoding system 48 may adjust a decoding rate of the received transport stream and/or smooth out reading of the audio samples within the transport stream, based on a ratio of the first difference and the second difference.

In one embodiment of the invention, a system for processing multimedia information may comprise an MPEG decoding system 48. The MPEG decoding system 48 may comprise a processor 67 that enables adjusting of a decoding rate for a received transport stream based on a ratio of a plurality of accumulated program clock reference (PCR) values and a corresponding plurality of accumulated system time clock (STC) values. The transport stream that is received by the MPEG decoding system 48 may comprise a plurality of audio samples. The processor 67 may enable decoding of at least a portion of the plurality of audio samples based on the adjusted decoding rate. The processor 67 may enable detecting of the plurality of PCR values within the transport stream received by the MPEG decoding system 48, and may store the detected plurality of PCR values within the PCR memory 63. The processor 67 may enable generation of the STC values based on incrementing a counter during decoding of the received transport stream.

The processor 67 may enable storing of the generated plurality of STC values within the STC memory 65, and may further enable calculation of a first difference between a current PCR value and a subsequent PCR value. The current PCR value and the subsequent PCR value may be selected from the plurality of accumulated PCR values that are stored in the PCR memory 63. The processor 67 may enable calculation of a second difference between a current STC value and a subsequent STC value. The current STC value and the subsequent STC value may be selected from the plurality of accumulated STC values. The processor 67 may enable adjusting of the decoding rate for the received transport stream based on a ratio of said first difference and said second difference.

Accordingly, aspects of the invention may be realized in hardware, software, firmware or a combination thereof. The invention may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

The invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for processing multimedia information, the method comprising: adjusting a decoding rate for a received transport stream based on a ratio of a plurality of accumulated program clock reference (PCR) values and a corresponding plurality of accumulated system time clock (STC) values.

2. The method according to claim 1, wherein said received transport stream comprises a plurality of audio samples.

3. The method according to claim 2, comprising decoding at least a portion of said plurality of audio samples based on said adjusted decoding rate.

4. The method according to claim 1, comprising detecting said plurality of PCR values within said received transport stream.

5. The method according to claim 4, comprising storing said detected plurality of PCR values within on-chip memory.

6. The method according to claim 1, comprising generating said plurality of STC values based on incrementing a counter during decoding of said received transport stream.

7. The method according to claim 6, comprising storing said generated plurality of STC values within on-chip memory.

8. The method according to claim 1, comprising calculating a first difference between a current PCR value and a subsequent PCR value, said current PCR value and said subsequent PCR value selected from said plurality of accumulated PCR values.

9. The method according to claim 8, comprising calculating a second difference between a current STC value and a subsequent STC value, said current STC value and said subsequent STC value selected from said plurality of accumulated STC values.

10. The method according to claim 9, comprising adjusting said decoding rate for said received transport stream based on a ratio of said first difference and said second difference.

11. A system for processing multimedia information, the system comprising: at least one processor that enables adjusting of a decoding rate for a received transport stream based on a ratio of a plurality of accumulated program clock reference (PCR) values and a corresponding plurality of accumulated system time clock (STC) values.

12. The system according to claim 11, wherein said received transport stream comprises a plurality of audio samples.

13. The system according to claim 12, wherein said at least one processor enables decoding of at least a portion of said plurality of audio samples based on said adjusted decoding rate.

14. The system according to claim 11, wherein said at least one processor enables detecting of said plurality of PCR values within said received transport stream.

15. The system according to claim 14, wherein said at least one processor enables storing of said detected plurality of PCR values within on-chip memory.

16. The system according to claim 11, wherein said at least one processor enables generating of said plurality of STC values based on incrementing a counter during decoding of said received transport stream.

17. The system according to claim 16, wherein said at least one processor enables storing of said generated plurality of STC values within on-chip memory.

18. The system according to claim 11, wherein said at least one processor enables calculating of a first difference between a current PCR value and a subsequent PCR value, said current PCR value and said subsequent PCR value selected from said plurality of accumulated PCR values.

19. The system according to claim 18, wherein said at least one processor enables calculating of a second difference between a current STC value and a subsequent STC value, said current STC value and said subsequent STC value selected from said plurality of accumulated STC values.

20. The system according to claim 19, wherein said at least one processor enables adjusting of said decoding rate for said received transport stream based on a ratio of said first difference and said second difference.

21. A machine-readable storage having stored thereon, a computer program having at least one code section for processing multimedia information, the at least one code section being executable by a machine for causing the machine to perform steps comprising: adjusting a decoding rate for a received transport stream based on a ratio of a plurality of accumulated program clock reference (PCR) values and a corresponding plurality of accumulated system time clock (STC) values.

22. The machine-readable storage according to claim 21, wherein said received transport stream comprises a plurality of audio samples.

23. The machine-readable storage according to claim 22, wherein said at least one code section comprises code for decoding at least a portion of said plurality of audio samples based on said adjusted decoding rate.

24. The machine-readable storage according to claim 21, wherein said at least one code section comprises code for detecting said plurality of PCR values within said received transport stream.

25. The machine-readable storage according to claim 24, wherein said at least one code section comprises code for storing said detected plurality of PCR values within on-chip memory.

26. The machine-readable storage according to claim 21, wherein said at least one code section comprises code for generating said plurality of STC values based on incrementing a counter during decoding of said received transport stream.

27. The machine-readable storage according to claim 26, wherein said at least one code section comprises code for storing said generated plurality of STC values within on-chip memory.

28. The machine-readable storage according to claim 21, wherein said at least one code section comprises code for calculating a first difference between a current PCR value and a subsequent PCR value, said current PCR value and said subsequent PCR value selected from said plurality of accumulated PCR values.

29. The machine-readable storage according to claim 28, wherein said at least one code section comprises code for calculating a second difference between a current STC value and a subsequent STC value, said current STC value and said subsequent STC value selected from said plurality of accumulated STC values.

30. The machine-readable storage according to claim 29, wherein said at least one code section comprises code for adjusting said decoding rate for said received transport stream based on a ratio of said first difference and said second difference.
